(19) United States
(12) Patent Application Publication
(10) Pub. No.: US 2026/0164237 A1
(43) Pub. Date: Jun. 11, 2026

(54) ELECTRONIC DEVICE FOR DEVICE AUTHENTICATION AND OPERATION METHOD THEREFOR

(71) Applicant: SAMSUNG ELECTRONICS CO., LTD., Suwon-si (KR)

(72) Inventor: Kyungho JEONG, Suwon-si (KR)

(21) Appl. No.: 19/181,256

(22) Filed: Apr. 16, 2025

Related U.S. Application Data
(63) Continuation of application No. PCT/KR2023/012299, filed on Aug. 18, 2023.

(30) Foreign Application Priority Data
Oct. 19, 2022 (KR) 10-2022-0134795

(51) Int. Cl. H04W 12/06; G06V 10/74; G06V 20/50; H04L 67/12; H04W 4/80; H04W 12/50; H04W 76/15

(52) U.S. Cl. CPC H04W 12/06; H04W 4/80; H04W 12/50; H04W 76/15; G06V 10/761; G06V 20/50; H04L 67/12

(57) ABSTRACT

An electronic device can include a camera module for capturing an image of the surrounding space in which at least one Internet-of-things (IoT) device is located; a first communication module; a second communication module; and at least one processor. The at least one processor can use the first communication module to form a first wireless communication link with an IoT device and receive first authentication information; identify a first user input commanding authentication of the IoT device; determine whether the direction of the electronic device and the IoT device match; use the second communication module to transmit an authentication request to the IoT device and receive second authentication information of the IoT device, if the direction of the electronic device and the IoT device match; and determine that the IoT device is matched to the electronic device if the second authentication information corresponds to the first authentication information.

### CROSS-REFERENCE TO RELATED APPLICATIONS

This application is a continuation application of International Application No. PCT/KR2023/012299 designating the United States, filed on Aug. 18, 2023, in the Korean Intellectual Property Receiving Office and claiming priority to Korean Patent Application No. 10-2022-0134795, filed on Oct. 19, 2022, in the Korean Intellectual Property Office, the disclosures of which are incorporated by reference herein in their entireties.

### BACKGROUND

### Technical Field

Embodiments of the disclosure relate to an electronic device for device authentication and a method for operating the same.

### Description of the Related Art

As IoT technology advances, IoT devices (e.g., TVs, refrigerators, vacuum cleaners, washers, smartphones, laptops, etc.) equipped with IoT functionality are widely used in households. As such, to remotely control the IoT devices through a user device, the IoT devices may be registered in an IoT server in association with the user device. In this regard, to authenticate an IoT device to be linked with a user device, authentication may be performed using augmented reality (AR) technology or a quick response (QR) code, and a method, such as physical manipulation (e.g., a button) of the IoT device, may be used.

Ultra-wideband (UWB) is a short-range wireless technology that may measure distances with an accuracy of several centimeters using pulses of about 2 nanoseconds in length based on a bandwidth of 500 MHz or more. UWB may transmit and receive data at low power over a wide frequency band, causing little interference with other wireless communication technologies, so it may be used in parallel with other wireless technologies, such as near field communication (NFC), Bluetooth, and Wi-Fi. UWB technology may enable new services, such as precise indoor positioning and location tracking of IoT devices.

### SUMMARY

Embodiments of the disclosure provide an electronic device and an operation method thereof for remotely performing authentication on an IoT device.

Embodiments of the disclosure also provide an electronic device and an operation method thereof for performing accurate authentication on an IoT device using both a camera and ultra-wideband (UWB) technology.

An electronic device, according to an embodiment of the disclosure, includes a camera module for capturing an image of a surrounding space where at least one IoT device is located. The electronic device, according to an embodiment, includes a first communication module supporting Bluetooth communication. The electronic device, according to an embodiment, includes a second communication module supporting ultra-wideband(UWB) communication. The electronic device, according to an embodiment, includes at least one processor electrically connected to a memory, the camera module, the first communication module, and the second communication module. The at least one processor, when executing instructions stored in the memory, individually or collectively can form a first wireless communication link with an IoT device using the first communication module. The at least one processor can receive first authentication information from the IoT device using the first communication module. The at least one processor can identify a first user input instructing to perform authentication of the IoT device. The at least one processor can determine whether directions of the IoT device and the electronic device match each other using the camera module and the second communication module. The at least one processor can, when the directions of the IoT device and the electronic device match each other, transmit an authentication request to the IoT device using the second communication module. The at least one processor can receive second authentication information about the IoT device using the second communication module. The at least one processor can, when identifying that the second authentication information corresponds to the first authentication information, determine that the IoT device matches the electronic device.

The at least one processor can obtain the image of the surrounding space through the camera module. The at least one processor can identify a location of a first object corresponding to the IoT device in the image. The at least one processor can identify a location of the IoT device through the second communication module. The at least one processor can, when identifying that the location of the first object corresponding to the IoT device in the image corresponds to the location of the IoT device obtained through the second communication module, determine that the directions of the IoT device and the electronic device match each other.

The at least one processor can determine whether there is another IoT device corresponding to the IoT device within a field of view of the camera. The at least one processor can, when determining that there is not the other IoT device, transmit the authentication request to the IoT device.

The at least one processor can, when determining that there is the other IoT device, identify a second object corresponding to the other IoT device in the image. The at least one processor can determine whether the first object and the second object are identical to each other. The at least one processor can, when determining that the first object and the second object are not identical to each other, transmit the authentication request to the IoT device.

The at least one processor can, when determining that the first object and the second object are identical to each other, obtain depth information about the surrounding space through the camera. The at least one processor can identify the IoT device based on the depth information. The at least one processor can transmit the authentication request to the IoT device.

The at least one processor can display a user interface regarding the authentication. The at least one processor can receive the first user input through the user interface. The at least one processor can, in response to determining that the directions of the IoT device and the electronic device match each other using the camera module and the second communication module, receive a second user input instructing to transmit the authentication request to the IoT device. The at least one processor can, in response to receiving the second user input, transmit the authentication request to the IoT device.

The electronic device can further include a memory. The at least one processor can, in response to determining that the IoT device matches the electronic device, store information about the IoT device received from the IoT device in the memory.

The at least one processor can, in response to determining that the IoT device matches the electronic device, transmit information about the IoT device to an IoT server.

In an embodiment, the authentication request may include identification information about the electronic device.

The at least one processor can, in response to determining that the directions of the electronic device and the IoT device match each other, form a second wireless communication link with the IoT device using the second communication module.

A method for operating an electronic device, according to an embodiment of the disclosure, may include forming a first wireless communication link with an IoT device using a Bluetooth technology. The method for operating the electronic device can include receiving first authentication information from the IoT device. The method for operating the electronic device can include identifying a first user input instructing to perform authentication of the IoT device. The method for operating the electronic device can include determining whether directions of the IoT device and the electronic device match each other using a camera module and an ultra-wideband (UWB) communication technology. The method for operating the electronic device can include, when the directions of the IoT device and the electronic device match each other, transmitting an authentication request to the IoT device using the UWB communication technology. The method for operating the electronic device can include receiving second authentication information about the IoT device using the UWB communication technology. The method for operating the electronic device can include, when identifying that the second authentication information corresponds to the first authentication information, determining that the IoT device matches the electronic device.

The method for operating the electronic device can include obtaining an image of a surrounding space through the camera module. The method for operating the electronic device can include identifying a location of a first object corresponding to the IoT device in the image. The method for operating the electronic device can include identifying a location of the IoT device using the UWB communication technology. The method for operating the electronic device can include, when identifying that the location of the first object corresponding to the IoT device in the image corresponds to the location of the IoT device obtained through the UWB communication technology, determining that the directions of the IoT device and the electronic device match each other.

The method for operating the electronic device can include determining whether there is another IoT device corresponding to the IoT device within a field of view of the camera module. The method for operating the electronic device can include, when determining that there is not the other IoT device, transmitting the authentication request to the IoT device.

The method for operating the electronic device can include, when determining that there is the other IoT device, identifying a second object corresponding to the other IoT device in the image. The method for operating the electronic device can include determining whether the first object and the second object are identical to each other. The method for operating the electronic device can include, when determining that the first object and the second object are not identical to each other, transmitting the authentication request to the IoT device.

The method for operating the electronic device can include, when determining that the first object and the second object are identical to each other, obtaining depth information about the surrounding space through the camera. The method for operating the electronic device can include identifying the IoT device based on the depth information. The method for operating the electronic device can include transmitting the authentication request to the IoT device.

The method for operating the electronic device can include displaying a user interface regarding device authentication. The method for operating the electronic device can include receiving the first user input through the user interface. The method for operating the electronic device can include, in response to determining that the directions of the IoT device and the electronic device match each other using the camera module and the UWB communication technology, receiving a second user input instructing to transmit the authentication request to the IoT device. The method for operating the electronic device can include, in response to receiving the second user input, transmitting the authentication request to the IoT device.

The method for operating the electronic device can include, in response to determining that the IoT device matches the electronic device, storing information about the IoT device received from the IoT device in the memory.

The method for operating the electronic device can include, in response to determining that the IoT device matches the electronic device, transmitting information about the IoT device to an IoT server.

In an embodiment, the authentication request may include identification information about the electronic device.

The method for operating the electronic device can include, in response to determining that the directions of the electronic device and the IoT device match each other, forming a second wireless communication link with the IoT device using the UWB communication technology.

According to the examples of the disclosure, it is possible to enhance user experience by simplifying a procedure for manipulating an IoT device and a user device, which needs to be performed by a user of the IoT device to authenticate the IoT device.

It is also possible to link the IoT device and the user device more conveniently by enabling authentication on the IoT device at a distance from the IoT device.

Effects obtainable from the disclosure are not limited to the above-mentioned effects, and other effects not mentioned may be apparent to one of ordinary skill in the art from the following description.

### BRIEF DESCRIPTION OF THE DRAWINGS

FIG. 1 illustrates an example IoT environment according to an embodiment;

FIG. 2 is a block diagram illustrating a configuration of an IoT device according to an embodiment;

FIG. 3 is a block diagram illustrating a configuration of a user device according to an embodiment;

FIG. 4 is a signaling flowchart for registering an IoT device according to an embodiment;

FIG. 5 is a flowchart illustrating operations of a user device according to an embodiment;

FIG. 6 illustrates an example user interface for authenticating an IoT device according to an embodiment; and

FIG. 7 illustrates an example user interface for authenticating an IoT device according to an embodiment.

In connection with the description of the drawings, the same or similar reference numerals may be used to denote the same or similar elements.

### DETAILED DESCRIPTION

It should be appreciated that various embodiments of the present disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The term “and/or” may denote a combination(s) of a plurality of related components as listed or any of the components.

Hereinafter, the working principle and embodiments of the present invention are described with reference to the accompanying drawings.

Among the schemes being used for authenticating IoT devices, augmented reality (AR) technology may obtain general information about the device, but may have difficulty in obtaining, e.g., device identification information. A scheme that performs authentication via a quick response (QR) code is capable of remote authentication, but deteriorate the user experience because the IoT device should locate the QR code and, to recognize the QR code, the user should scan the QR code near the IoT device. Further, manipulating a physical button on the IoT device requires direct manipulation of a specific button of the IoT device and manipulation of the IoT device at a short distance, causing user inconvenience.

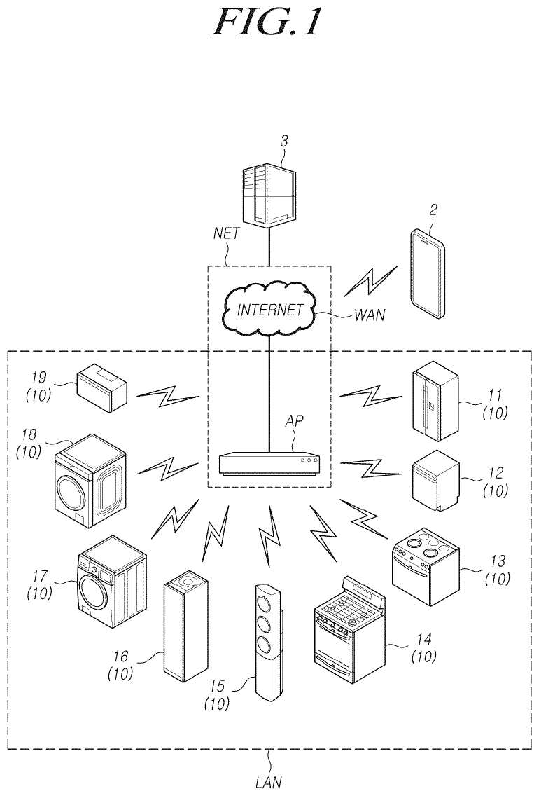

FIG. 1 illustrates an example IoT environment according to an embodiment.

The IoT device 10, according to an embodiment, may be connected to another IoT device through a network NET, or may be connected to the user device 2 and the server 3.

The IoT device 10, according to an embodiment of the disclosure, may include various types of home appliances. For example, the IoT device 10 may include at least one of home appliances such as a refrigerator 11, a dishwasher 12, an electric range 13, an electric oven 14, an air conditioner 15, a clothes care device 16, a washing machine 17, a dryer 18, a microwave oven 19, a robot vacuum, and a vacuum cleaner. The aforementioned home appliances are merely examples, and although not the aforementioned home appliances, any device that may be connected to another home appliance, user device, or server through a network and are capable of performing operations described below may be included in the IoT device 10 according to an embodiment.

The server 3, according to an embodiment, may include a communication module capable of communicating with the IoT device 10 and the user device 2, at least one processor capable of processing data received from the IoT device 10 or the user device 2, and at least one memory capable of storing a program for processing data or processed data. The server 3 may be implemented as various computing devices such as a workstation, a cloud, a data drive, and a data station.

The user device 2, according to an embodiment, may include a communication module capable of communicating with the IoT device 10 and the server 3, the user interface for receiving the user input or outputting information to the user, at least one processor for controlling the operation of the user device 2, and at least one memory storing a program for controlling the operation of the user device 2.

The user device 2, according to an embodiment of the disclosure, may be carried by the user, may be placed in the user's home or office, and may include a personal computer, a terminal, a mobile phone, a smart phone, a handheld device, a wearable device, or the like.

A program for controlling the IoT device 10, in other words, an application, may be stored in the memory of the user device 2 according to an embodiment. The user device 2 may be sold with or without such an application installed thereon. With no application installed on the user device 2, the user may download and install the application from an external server that provides the application.

In an embodiment, the user may control the IoT device 10 by using an application installed on the user device 2. For example, the user may create an account managed by the server 3, and the account of the user may be identified by an ID and a password set by the user. The IoT device 10 may be registered on the user's account according to a predetermined procedure. For example, when the IoT device 10 is registered, identification information such as a serial number or a MAC address allocated to each IoT device 10 may be used. When the application installed on the user device 2 is executed and logged in to the user account, the user may perform desired control on the IoT device 10 using the user device 2.

In an embodiment, the network NET may include both a wired network and a wireless network. The wired network may include a cable network, a telephone network, or the like, and the wireless network may include all networks that transmit and receive signals through radio waves. The wired network and the wireless network may be connected to each other.

In an embodiment, the network NET may include a wide area network (WAN) such as the Internet and a local area network (LAN) formed around an access point (AP).

In an embodiment, the AP may connect a local area network (LAN) to which the IoT device 10 and the user device 2 are connected to a wide area network (WAN) to which the server 3 is connected. The IoT device 10 or the user device 2 may be connected to the server 3 through the wide area network (WAN).

In an embodiment, the AP may communicate with the IoT device 10 and the user device 2 using wireless communication such as Wi-Fi (Wi-Fi™, IEEE 802.11), Bluetooth (Bluetooth™, IEEE 802.15.1), Zigbee (IEEE 802.15.4), or the like, and may access the wide area network (WAN) using wired communication.

In an embodiment, the IoT device 10 may transmit information about its operation or state to the server 3 through the network NET. The information may be transmitted when a request is received from the server 3, when a specific event occurs on the IoT device 10, or periodically or in real-time. When the information about the operation or the state is received from the IoT device 10, the server 3 may update the stored information and transmit the updated information about the operation and the state of the IoT device 10 to the user device 2 through the network NET.

In an embodiment, the IoT device 10 may obtain various pieces of information from the server 3 and provide the obtained information to the user. For example, the IoT device 10 may obtain information such as weather, news, recipe, washing method, etc. from the server 3, and output the obtained information through the user interface.

In an embodiment, the IoT device 10 may operate according to a control command received from the server 3. To that end, the IoT device 10 may obtain prior approval of the user for operating according to the control command of the server 3 without a user input. Further, the IoT device 10 may provide information about the operation or state of the IoT device 10 to the server 3 according to prior approval of the user.

In an embodiment, the user device 2 may provide information about the user (e.g., the user's location or health condition) to the server 3 according to prior approval of the user.

In an embodiment, the server 3 may process the information about the operation or state of the IoT device 10 and the information about the user of the user device 2 using a technology such as artificial intelligence, and may transmit a control command to the IoT device 10 based on the processing result.

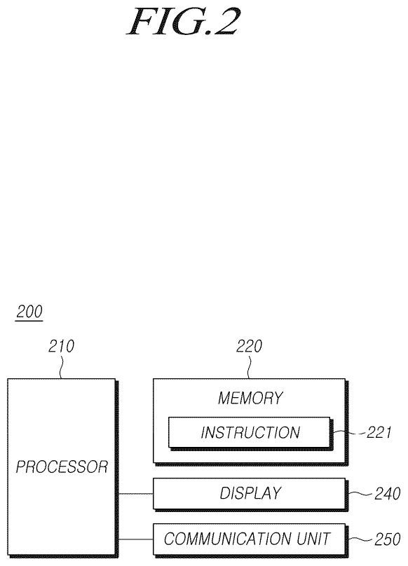

FIG. 2 is a block diagram illustrating a configuration of an IoT device according to an embodiment. The IoT device of FIG. 2 may include an electronic device corresponding to the IoT device 10 of FIG. 1.

According to an embodiment, the IoT device 200 may include a processor 210, a memory 220, a display 240, and a communication unit 250. The IoT device 200 may further include an image input unit (not shown). The IoT device 200 may include additional components other than the illustrated components, or at least one of the illustrated components may be omitted.

According to an embodiment, the memory 220 is a storage medium used by the IoT device 200, and may store data such as at least one instruction 221 or setting information corresponding to at least one program. The program may include an operating system (OS) program and various application programs.

The memory 220 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to an embodiment, the image input unit (not shown) may receive images and image information through a tuner (not shown), an input/output unit (not shown), or the communication unit 250. The image input unit may include at least one of the tuner and the input/output unit. The tuner may tune and select only the frequency of the broadcast channel to be received by the IoT device 200 among many radio components, by amplifying, mixing, and resonating the broadcast signals wiredly/wirelessly received. The broadcast signal may include video, audio, and additional data (e.g., electronic program guide (EPG)). The tuner may receive real-time broadcast channels (or real-time viewing images) from various broadcast sources, such as terrestrial broadcasts, cable broadcasts, satellite broadcasts, Internet broadcasts, and the like. The tuner may be implemented integrally with the IoT device 200 or may be implemented as a separate tuner electrically connected to the IoT device 200. The input/output unit may include at least one of a high definition multimedia interface (HDMI) input port, a component input jack, a PC input port, and a USB input jack capable of receiving an image and image information from an external device of the IoT device 200 under the control of the processor 210. It is obvious to one of ordinary skill in the art that the input/output unit may be added, deleted, and/or changed according to the performance and structure of the IoT device 200.

According to an embodiment, the display 240 may perform functions for outputting information in the form of numbers, characters, images, and/or graphics. The display 240 may include at least one hardware module for outputting. The at least one hardware module may include at least one of, e.g., a liquid crystal display (LCD), a light emitting diode (LED), a light emitting polymer display (LPD), an organic light emitting diode (OLED), an active matrix organic light emitting diode (AMOLED), or flexible LED (FLED). The display 240 may display a screen corresponding to data received from the processor 210. The display 240 may be referred to as an ‘output unit’, a ‘display unit’, or by other terms having an equivalent technical meaning.

According to an embodiment, the communication unit 250 may provide a wired/wireless communication interface enabling communication with an external device. The communication unit 250 may include at least one of a wired Ethernet, a wireless LAN communication unit, and a short-range communication unit. The wireless LAN communication unit may include, e.g., Wi-Fi, and may support the wireless LAN standard (IEEE802.11x) of the institute of electrical and electronics engineers (IEEE). The wireless LAN communication unit may be wirelessly connected to an access point (AP) under the control of the processor 210. The short-range communication unit may perform short-range communication wirelessly with an external device under the control of the processor 210. Short-range communication may include Bluetooth, Bluetooth low energy, infrared data association (IrDA), ultra-wideband (UWB), and near-field communication (NFC). The external device may include a server device and a mobile terminal (e.g., phone, tablet, etc.) providing, e.g., images. The communication unit 250 may include a communication module for providing Bluetooth communication and a communication module for providing UWB communication.

According to an embodiment, the processor 210 may control at least one other component of the IoT device 200 and/or execute computation or data processing regarding communication by executing at least one instruction 221 stored in the memory 220. The processor 210 may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

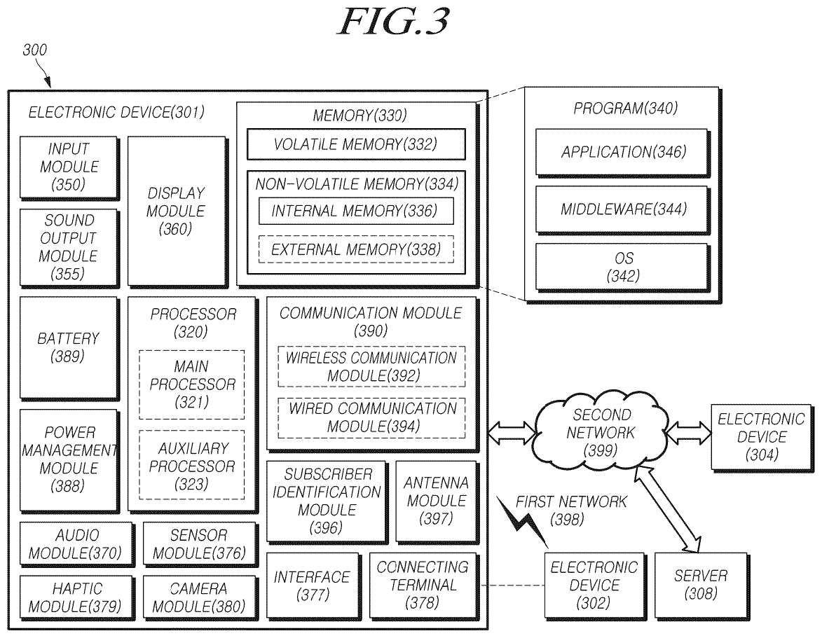

FIG. 3 is a block diagram illustrating an electronic device 301 in a network environment 300 according to various embodiments.

Referring to FIG. 3, the electronic device 301 in the network environment 300 may communicate with at least one of an electronic device 302 via a first network 398 (e.g., a short-range wireless communication network), or an electronic device 304 or a server 308 via a second network 399 (e.g., a long-range wireless communication network). According to an embodiment, the electronic device 301 may communicate with the electronic device 304 via the server 308. According to an embodiment, the electronic device 301 may include a processor 320, memory 330, an input module 350, a sound output module 355, a display module 360, an audio module 370, a sensor module 376, an interface 377, a connecting terminal 378, a haptic module 379, a camera module 380, a power management module 388, a battery 389, a communication module 390, a subscriber identification module (SIM) 396, or an antenna module 397. In an embodiment, at least one (e.g., the connecting terminal 378) of the components may be omitted from the electronic device 301, or one or more other components may be added in the electronic device 101. According to an embodiment, some (e.g., the sensor module 376, the camera module 380, or the antenna module 397) of the components may be integrated into a single component (e.g., the display module 360).

The processor 320 may execute, for example, software (e.g., a program 340) to control at least one other component (e.g., a hardware or software component) of the electronic device 301 coupled with the processor 320, and may perform various data processing or computation. According to an embodiment, as at least part of the data processing or computation, the processor 320 may store a command or data received from another component (e.g., the sensor module 376 or the communication module 390) in volatile memory 332, process the command or the data stored in the volatile memory 332, and store resulting data in non-volatile memory 334. According to an embodiment, the processor 320 may include a main processor 321 (e.g., a central processing unit (CPU) or an application processor (AP)), or an auxiliary processor 323 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 301 includes the main processor 321 and the auxiliary processor 323, the auxiliary processor 323 may be configured to use lower power than the main processor 321 or to be specified for a designated function. The auxiliary processor 323 may be implemented as separate from, or as part of the main processor 321.

The auxiliary processor 323 may control at least some of functions or states related to at least one component (e.g., the display module 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). According to an embodiment, the auxiliary processor 323 (e.g., an image signal processor or a communication processor) may be implemented as part of another component (e.g., the camera module 380 or the communication module 390) functionally related to the auxiliary processor 123. According to an embodiment, the auxiliary processor 323 (e.g., the neural processing unit) may include a hardware structure specified for artificial intelligence model processing. The artificial intelligence model may be generated via machine learning. Such learning may be performed, e.g., by the electronic device 301 where the artificial intelligence is performed or via a separate server (e.g., the server 308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 330 may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 or the non-volatile memory 334.

The program 340 may be stored in the memory 330 as software, and may include, for example, an operating system (OS) 342, middleware 344, or an application 346.

The input module 350 may receive a command or data to be used by other component (e.g., the processor 320) of the electronic device 301, from the outside (e.g., a user) of the electronic device 301. The input module 350 may include, for example, a microphone, a mouse, a keyboard, keys (e.g., buttons), or a digital pen (e.g., a stylus pen).

The sound output module 355 may output sound signals to the outside of the electronic device 301. The sound output module 355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 360 may visually provide information to the outside (e.g., a user) of the electronic device 301. The display 360 may include, for example, a display, a hologram device, or a projector and control circuitry to control a corresponding one of the display, hologram device, and projector. According to an embodiment, the display 360 may include a touch sensor configured to detect a touch, or a pressure sensor configured to measure the intensity of a force generated by the touch.

The audio module 370 may convert a sound into an electrical signal and vice versa. According to an embodiment, the audio module 370 may obtain the sound via the input module 350, or output the sound via the sound output module 355 or a headphone of an external electronic device (e.g., an electronic device 302) directly (e.g., wiredly) or wirelessly coupled with the electronic device 301.

The sensor module 376 may detect an operational state (e.g., power or temperature) of the electronic device 301 or an environmental state (e.g., a state of a user) external to the electronic device 101, and then generate an electrical signal or data value corresponding to the detected state. According to an embodiment, the sensor module 376 may include, e.g., a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 377 may support one or more specified protocols to be used for the electronic device 301 to be coupled with the external electronic device (e.g., the electronic device 302) directly (e.g., wiredly) or wirelessly. According to an embodiment, the interface 377 may include, for example, a high definition multimedia interface (HDMI), a universal serial bus (USB) interface, a secure digital (SD) card interface, or an audio interface.

A connecting terminal 378 may include a connector via which the electronic device 301 may be physically connected with the external electronic device (e.g., the electronic device 302). According to an embodiment, the connecting terminal 378 may include, for example, a HDMI connector, a USB connector, a SD card connector, or an audio connector (e.g., a headphone connector).

The haptic module 379 may convert an electrical signal into a mechanical stimulus (e.g., a vibration or motion) or electrical stimulus which may be recognized by a user via his tactile sensation or kinesthetic sensation. According to an embodiment, the haptic module 379 may include, for example, a motor, a piezoelectric element, or an electric stimulator.

The camera module 380 may capture a still image or moving images. According to an embodiment, the camera module 380 may include one or more lenses, image sensors, image signal processors, or flashes.

The power management module 388 may manage power supplied to the electronic device 301. According to one embodiment, the power management module 388 may be implemented as at least part of, for example, a power management integrated circuit (PMIC).

The battery 389 may supply power to at least one component of the electronic device 301. According to an embodiment, the battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more communication processors that are operable independently from the processor 320 (e.g., the application processor (AP)) and supports a direct (e.g., wired) communication or a wireless communication. According to an embodiment, the communication module 390 may include a wireless communication module 392 (e.g., a cellular communication module, a short-range wireless communication module, or a global navigation satellite system (GNSS) communication module) or a wired communication module 394 (e.g., a local area network (LAN) communication module or a power line communication (PLC) module). A corresponding one of these communication modules may communicate with the external electronic device 304 via a first network 398 (e.g., a short-range communication network, such as Bluetooth™, wireless-fidelity (Wi-Fi) direct, or infrared data association (IrDA)) or a second network 399 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 392 may identify or authenticate the electronic device 301 in a communication network, such as the first network 398 or the second network 399, using subscriber information (e.g., international mobile subscriber identity (IMSI)) stored in the subscriber identification module 396.

The wireless communication module 392 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 392 may support a high-frequency band (e.g., the mmWave band) to achieve, e.g., a high data transmission rate. The wireless communication module 392 may support various technologies for securing performance on a high-frequency band, such as, e.g., beamforming, massive multiple-input and multiple-output (massive MIMO), full dimensional MIMO (FD-MIMO), array antenna, analog beamforming, or large scale antenna. The wireless communication module 392 may support various requirements specified in the electronic device 301, an external electronic device (e.g., the electronic device 304), or a network system (e.g., the second network 399). According to an embodiment, the wireless communication module 392 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 397 may transmit or receive a signal or power to or from the outside (e.g., the external electronic device). According to an embodiment, the antenna module 397 may include an antenna including a radiator formed of a conductor or conductive pattern formed on a substrate (e.g., a printed circuit board (PCB)). According to an embodiment, the antenna module 397 may include a plurality of antennas (e.g., an antenna array). In this case, at least one antenna appropriate for a communication scheme used in a communication network, such as the first network 398 or the second network 399, may be selected from the plurality of antennas by, e.g., the communication module 390. The signal or the power may then be transmitted or received between the communication module 390 and the external electronic device via the selected at least one antenna. According to an embodiment, other parts (e.g., radio frequency integrated circuit (RFIC)) than the radiator may be further formed as part of the antenna module 397. According to various embodiments, the antenna module 397 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 301 and the external electronic device 304 via the server 308 coupled with the second network 399. The external electronic devices 302 or 304 each may be a device of the same or a different type from the electronic device 301. According to an embodiment, all or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 301. The electronic device 301 may provide the outcome, with or without further processing of the outcome, as at least part of a reply to the request. To that end, a cloud computing, distributed computing, mobile edge computing (MEC), or client-server computing technology may be used, for example. The electronic device 301 may provide ultra low-latency services using, e.g., distributed computing or mobile edge computing. In another embodiment, the external electronic device 304 may include an Internet-of-things (IoT) device. The server 308 may be an intelligent server using machine learning and/or a neural network. According to an embodiment, the external electronic device 304 or the server 308 may be included in the second network 399. The electronic device 301 may be applied to intelligent services (e.g., smart home, smart city, smart car, or health-care) based on 5G communication technology or IoT-related technology.

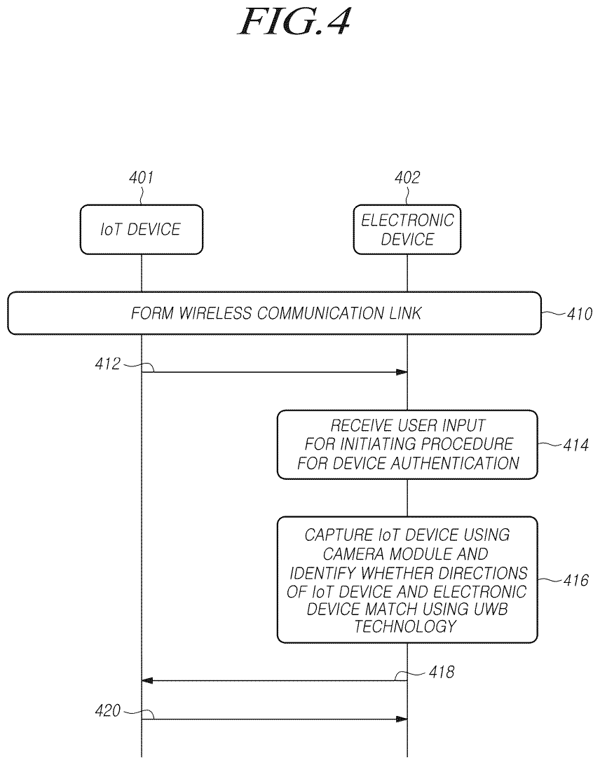

FIG. 4 is a signaling flowchart for registering an IoT device according to an embodiment. The IoT device 10 of FIG. 4 may represent the IoT device 10 of FIG. 1 or the IoT device 200 of FIG. 2. The electronic device 402 of FIG. 4 may represent the user device 2 of FIG. 1 or the electronic device 301 of FIG. 3.

According to an embodiment, in operation 410, the IoT device 401 and the electronic device 402 may establish a wireless communication link.

In an embodiment, the electronic device 402 may form a wireless communication link with the IoT device 401 using a short-range wireless communication technology (e.g., Bluetooth low energy (BLE)). The IoT device 401 may generate an advertising signal. The electronic device 402 may perform an operation of scanning Bluetooth electronic devices adjacent to the electronic device 402. The electronic device 402 may identify the advertising signal generated from the IoT device 401 through the scan operation. The electronic device 402 may identify the IoT device 401 based on identifying the advertising signal, and may transmit a connection request to the IoT device 401. After receiving the connection request from the electronic device 402, the IoT device 401 may transmit a connection response to the electronic device 402. The electronic device 402 may form a wireless communication link after receiving the connection response from the IoT device 401.

According to an embodiment, in operation 412, the IoT device 401 may transmit identification information (e.g., medium access control (MAC) address, serial number, etc.) about the IoT device 401 to the electronic device 402 through the wireless communication link generated in operation 410.

In an embodiment, the IoT device 401 may transmit the identification information about the IoT device 401 to the electronic device 402 in response to receiving the user's input for device registration.

According to an embodiment, in operation 414, the electronic device 402 may receive the user input for initiating a procedure for device authentication. In order for the IoT device to be linked to the user's terminal, a specific application may be installed on the user's terminal. The electronic device 402 may receive the user input through the user interface displayed when executing such a specific application.

In an embodiment, the user input for initiating a procedure for device authentication may be identified through the user interface for device authentication displayed on the electronic device 402. The user input may include various types of user inputs such as touch input, tap, double tap, or the like.

According to an embodiment, in operation 416, the electronic device 402 may capture the IoT device using the camera module, and may identify whether the directions of the IoT device and the electronic device match using UWB technology.

In an embodiment, the electronic device 402 may obtain an image of at least one IoT device located adjacent to the electronic device 402 using a camera. The at least one IoT device may include the IoT device 401. The image may mean an image represented on the screen being captured through the camera, rather than a single static image captured in one frame.

In an embodiment, the electronic device 402 may identify location information about the IoT device 401 using an ultra-wideband (UWB). For example, the electronic device 402 may identify the location of at least one IoT device included in the image obtained through the camera using the UWB. The electronic device 402 may identify the location of the IoT device 401 using the UWB.

In an embodiment, the electronic device 402 may determine whether the direction of the IoT device 401 identified through the UWB technology matches the direction of the IoT device captured through the camera.

In an embodiment, when the direction of the IoT device 401 identified through the UWB technology matches the direction of the IoT device captured through the camera, in operation 418, the electronic device 402 may transmit a device information request to the IoT device 401.

In an embodiment, when the direction of the IoT device 401 identified through the UWB technology matches the direction of the IoT device captured through the camera, the electronic device 402 may determine whether there is another IoT device corresponding to the IoT device 401 among the at least one IoT device. The other IoT device corresponding to the IoT device 401 may mean the same type of IoT device (e.g., if the IoT device 401 is an air purifier, the other IoT device is an air purifier).

In an embodiment, when there is no other IoT device corresponding to the IoT device 401 among the at least one IoT device, the electronic device 402 may transmit a device information request to the IoT device 401.

In an embodiment, when there is another IoT device corresponding to the IoT device 401 among the at least one IoT device, the electronic device 402 may determine whether the IoT device 401 may be identified based on the captured image. For example, when the electronic device 402 determines that the image of the IoT device 401 and the image of the other IoT device correspond to each other (e.g., when it is determined that they are the same product (e.g., when the match degree of the appearance identified through artificial intelligence is a predetermined ratio or more), the electronic device 402 may determine that the IoT device 401 and the other IoT device may not be identified. For example, when the electronic device 402 determines that the image of the IoT device 401 and the image of the other IoT device do not correspond to each other (e.g., when they are different products, e.g., when they both are the same in product type as air purifiers, but belong to different subcategories (size, shape, etc.)), the electronic device 402 may determine that the IoT device 401 and the other IoT device may be identified.

In an embodiment, when the IoT device 401 may be identified, the electronic device 402 may transmit a device information request to the IoT device 401.

In an embodiment, when the IoT device 401 may not be identified, the electronic device 402 may identify the IoT device 401 using depth information obtained through a camera or a depth sensor. For example, the electronic device 402 may identify the IoT device being captured by the electronic device 402 by grasping the structure of the space visible in the field of view captured through the camera based on the depth information obtained through the depth sensor. As such, the structure of the surrounding space of the electronic device 402 may be grasped through, e.g., the depth sensor, and filtering may be performed on the other IoT device than the IoT device 401.

In an embodiment, the device information request may include information indicating that the directions of the electronic device 402 and the IoT device 401 match.

According to an embodiment, the device information request may include device information about the electronic device 402. For example, information about the serial number, MAC address, etc. of the electronic device 402 required for the IoT device 401 to authenticate the electronic device 402 may be included.

According to an embodiment, in operation 420, the IoT device 401 may transmit identification information about the IoT device 401 to the electronic device 402 through UWB rather than a wireless communication link.

In an embodiment, the IoT device 401 may include a UWB sensor. The IoT device 401 may transmit authentication information about the IoT device 401 to the electronic device 402 using the UWB sensor.

In an embodiment, the device information request may include information about relative locations of the electronic device 402 and the IoT device 401.

In an embodiment, the electronic device 402 may perform authentication on the IoT device 401 based on information about the IoT device 401 received through the UWB and information about the IoT device 401 received through the wireless communication link in operation 412. For example, when the information about the IoT device 401 received through the wireless communication link matches the information about the IoT device 401 received through the UWB, the electronic device 402 may determine that the IoT device 401 is an IoT device to be registered. Thereafter, the electronic device 402 may store the information about the IoT device 401 in the memory. For example, when the information about the IoT device 401 received through the wireless communication link does not match the information about the IoT device 401 received through the UWB, the electronic device 402 may determine that the IoT device 401 is not an IoT device to be registered.

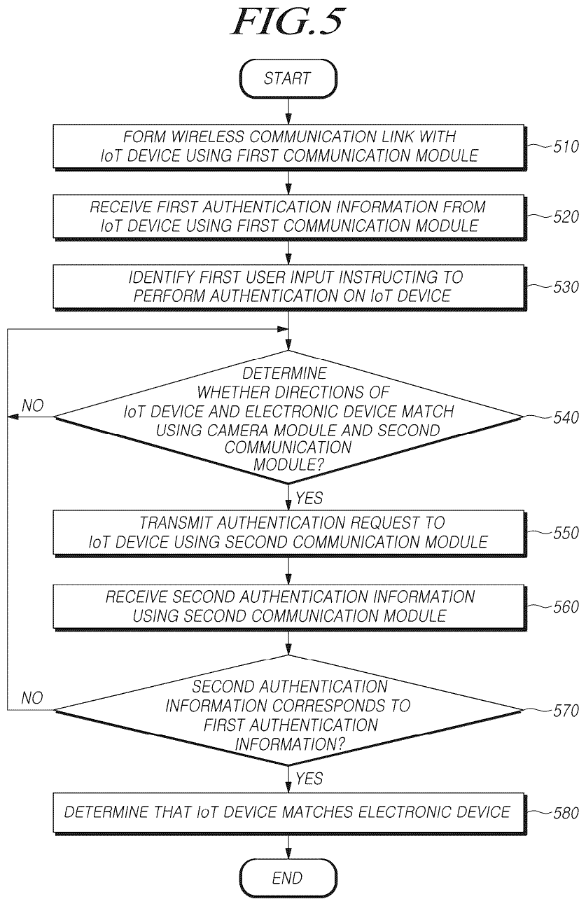

FIG. 5 illustrates an operation flow of an electronic device according to an embodiment. The electronic device of FIG. 5 may be a device corresponding to the user device 2 of FIG. 1, the electronic device 301 of FIG. 3, and/or the electronic device 402 of FIG. 4.

According to an embodiment, in operation 510, the electronic device may form the wireless communication link with the IoT device using the first communication module.

In an embodiment, the electronic device may form the wireless communication link with the IoT device using Bluetooth technology. The electronic device may scan the Bluetooth connection signal received from the IoT device and transmit a Bluetooth connection request to the IoT device. When the electronic device receives a Bluetooth connection response from the IoT device, the wireless communication link may be formed.

According to an embodiment, in operation 520, the electronic device may receive first authentication information from the IoT device using the first communication module.

In an embodiment, the electronic device may receive the first authentication information from the IoT device through the wireless communication link formed using the first communication module.

In an embodiment, the first authentication information may mean identification information about the IoT device received through the wireless communication link. For example, the identification information about the IoT device may include information about the product number, the serial number, and the MAC address of the IoT device.

According to an embodiment, in operation 530, the electronic device may identify a first user input instructing to perform authentication on the IoT device.

In an embodiment, the authentication on the IoT device may mean an authentication procedure performed by the user of the electronic device to control the IoT device through the electronic device. When the authentication on the IoT device is completed, the electronic device may transmit information about the IoT device to the IoT server and store the information about the IoT device in the memory of the electronic device. Accordingly, the IoT device for which authentication has been completed may be remotely controlled by the user of the electronic device through the electronic device.

In an embodiment, the first user input may be identified through the user interface displayed on the electronic device when the user interface regarding device authentication is executed. The user interface may include information about the current electronic device and other IoT devices registered, information about IoT devices that may be registered, or the like.

According to an embodiment, in operation 540, the electronic device may determine whether the directions of the IoT device and the electronic device match using the camera module and the second communication module. The user of the electronic device may capture the surrounding space of the electronic device using a camera function activated when receiving a first user input. Other IoT devices including an IoT device to be authenticated may be located in the surrounding space of the electronic device.

In an embodiment, the electronic device may obtain an image regarding the surrounding space in which at least one IoT device is located. The at least one IoT device may include an IoT device.

In an embodiment, the electronic device may identify the location of the IoT device based on the UWB communication technology of the second communication module.

According to an embodiment, the electronic device may determine whether the IoT device is located in the field of view of the camera.

In an embodiment, the electronic device may identify the location of the object corresponding to the IoT device from the image obtained using the camera. In an embodiment, the electronic device may identify the IoT device located in the center of the field of view.

In an embodiment, the electronic device may determine whether the location of the IoT device obtained using the UWB matches the location of the object identified through the camera. In an embodiment, the electronic device may determine whether the direction in which the IoT device located in the center of the field of view is located corresponds to the location of the IoT device obtained using the UWB.

In an embodiment, when the electronic device determines that the directions of the electronic device and the IoT device match each other, the electronic device may perform operation 550.

In an embodiment, even when the electronic device determines that the directions of the IoT device and the electronic device match in operation 540, the electronic device may, rather than immediately performing operation 550, determine whether the other IoT device corresponding to the IoT device is located in the field of view of the camera. The other IoT device corresponding to the IoT device (hereinafter, referred to as the other IoT device) may mean the same type of device as the IoT device. For example, when the IoT device is an air purifier, the other IoT device may also mean an air purifier. The UWB signal transmitted and received using the second communication module may pass through the wall so that an IoT device in a house other than the home of the user of the electronic device may be sensed, or an IoT device in another room in the same direction may be located within the field of view. To filter out such a case, the electronic device may determine whether there is the same type of device as the IoT device within the field of view of the camera.

In an embodiment, when the electronic device determines that the directions of the IoT device and the electronic device match each other, and determines that the other IoT device corresponding to the IoT device is not located in the field of view of the camera, the electronic device may perform operation 550.

In an embodiment, when the electronic device determines that the directions of the IoT device and the electronic device match and that the other IoT device corresponding to the IoT device is located within the field of view of the camera, the electronic device may determine whether the IoT device may be identified based on the image obtained through the camera. The electronic device may identify the images of the IoT device and the other IoT device through the camera, and may determine whether the IoT device and the other IoT device have the same appearance. When determining that the images of the IoT device and the other IoT device are the same, the electronic device may determine that the IoT device may not be identified, and when determining that the images of the IoT device and the other IoT device are different, the electronic device may determine that the IoT device may be identified.

In an embodiment, when the electronic device determines that the directions of the IoT device and the electronic device match, the other IoT device corresponding to the IoT device is located within the field of view of the camera, and determines that the IoT device may be identified, the electronic device may perform operation 550.

In an embodiment, when the electronic device determines that the directions of the IoT device and the electronic device match, the other IoT device corresponding to the IoT device is located within the field of view of the camera, and the IoT device may not be identified, the electronic device may identify the IoT device based on depth information obtained through, e.g., a depth sensor. The electronic device may identify exactly which IoT device the electronic device is capturing by grasping the structure of the surrounding space within the field of view of the camera based on the 3D depth information. When the electronic device identifies the IoT device, the electronic device may perform operation 550.

According to an embodiment, in operation 550, the electronic device may transmit an authentication request to the IoT device using the second communication module.

In an embodiment, the authentication request may include identification information (e.g., product number, product identifier, MAC address, etc.) about the electronic device.

In an embodiment, the authentication request may include information indicating that the directions of the electronic device and the IoT device match each other.

According to an embodiment, in operation 560, the electronic device may receive second authentication information from the IoT device using the second communication module.

In an embodiment, the second authentication information may include identification information about the IoT device.

According to an embodiment, in operation 570, the electronic device may determine whether the second authentication information corresponds to the first authentication information.

In an embodiment, when determining that the second authentication information corresponds to the first authentication information, the electronic device may determine that the IoT device matches the electronic device in operation 580.

In an embodiment, when the electronic device determines that the IoT device matches the electronic device, the electronic device may store information about the IoT device (e.g., first authentication information and second authentication information) in the memory.

In an embodiment, when the electronic device determines that the IoT device matches the electronic device, the electronic device may transmit information about the IoT device to the IoT server.

In an embodiment, when determining that the second authentication information does not correspond to the first authentication information, the electronic device may perform operation 540 again.

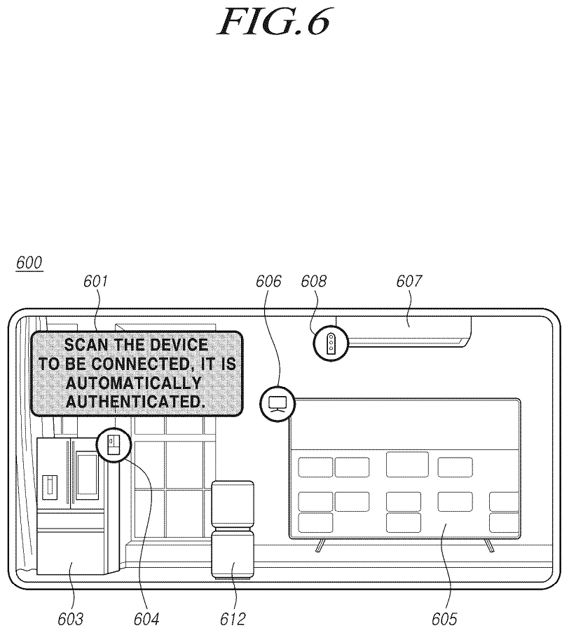

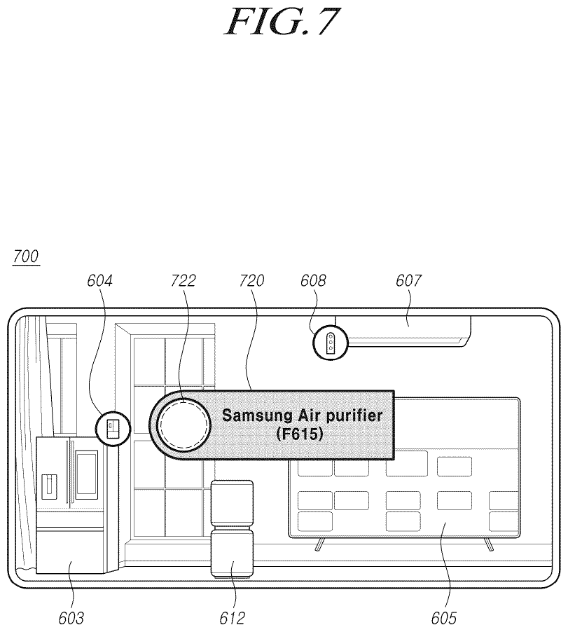

FIG. 6 illustrates an example user interface for authenticating an IoT device according to an embodiment. FIG. 7 illustrates an example user interface where authentication on an IoT device has been completed according to an embodiment. The electronic device described in FIGS. 6 and 7 may be a device corresponding to the user device 2 of FIG. 1, the electronic device 301 of FIG. 3, and/or the electronic device 402 of FIG. 4.

According to an embodiment, the user interface 600 may mean a user interface displayed when an application for device authentication installed in the electronic device is executed.

In an embodiment, the user interface 600 may mean the user interface displayed on the electronic device in operation 416 of FIG. 4 and operation 540 of FIG. 5.

According to an embodiment, the user interface 600 may include IoT devices 603, 605, and 607 connected to the electronic device and objects 604, 606, and 608 indicating the IoT devices. For example, the user interface 600 may include a refrigerator 603 connected to the electronic device and an object 604 indicating the refrigerator. For example, the user interface 600 may include a TV 605 connected to the electronic device and an object 606 indicating the TV. For example, the user interface 600 may include an air conditioner 607 connected to the electronic device and an object 608 indicating the air conditioner 607.

According to an embodiment, the user interface 600 may display a surrounding space captured through the camera of the electronic device.

According to an embodiment, the user interface 600 may display an IoT device 612 to be registered. For example, an air purifier on which device authentication is to be performed may be displayed on the screen captured through the camera.

According to an embodiment, the user interface 600 may include a first object 601 indicating information instructing to capture the IoT device to be authenticated.

In an embodiment, when a user input is received through the second object 604, 606, or 608 indicating the IoT device, a screen (not shown) for searching for information about the connected IoT device 603, 605, or 607 or changing (e.g., releasing or updating) the connection settings may be displayed.

In an embodiment, when the electronic device determines that the directions of the IoT device and the electronic device match while displaying the user interface 600, the user interface 700 may be displayed.

According to an embodiment, the user interface 700 may include an object 720 that displays information about the recognized IoT device. For example, when determining that the directions of the air purifier 612 and the electronic device match, the electronic device may display information (e.g., Air Purifier) about the recognized IoT device 612.

In an embodiment, the user interface 700 may include an object 722 for receiving a user input for transmitting an authentication request to the IoT device having the matching direction. When receiving a user input through the object 722, the electronic device may transmit an authentication request to the IoT device 612.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to an embodiment of the disclosure, the electronic devices are not limited to those described above.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 340) including one or more instructions that are stored in a storage medium (e.g., internal memory 336 or external memory 338) that is readable by a machine (e.g., the electronic device 301). For example, a processor (e.g., the processor 320) of the machine (e.g., the electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a camera module for capturing an image of a surrounding space where at least one Internet-of-things (IoT) device is located;
a first communication module supporting Bluetooth communication;
a second communication module supporting ultra-wideband (UWB) communication;
a memory; and
at least one processor electrically connected to the memory, the camera module, the first communication module, and the second communication module, wherein the at least one processor, when executing instructions stored in the memory, individually or collectively:
forms a first wireless communication link with an IoT device using the first communication module;
receives first authentication information from the IoT device using the first communication module;
identifies a first user input instructing to perform authentication of the IoT device;
determines whether directions of the IoT device and the electronic device match each other using the camera module and the second communication module;
when the directions of the IoT device and the electronic device match each other, transmits an authentication request to the IoT device using the second communication module;
receives second authentication information about the IoT device using the second communication module; and
when identifying that the second authentication information corresponds to the first authentication information, determines that the IoT device matches the electronic device.

2. The electronic device of claim 1, wherein the at least one processor, when executing instructions stored in the memory, individually or collectively:
obtains the image of the surrounding space through the camera module;
identifies a location of a first object corresponding to the IoT device in the image;
identifies a location of the IoT device through the second communication module; and
when identifying that the location of the first object corresponding to the IoT device in the image corresponds to the location of the IoT device obtained through the second communication module, determines that the directions of the IoT device and the electronic device match each other.

3. The electronic device of claim 2, wherein the at least one processor, when executing instructions stored in the memory, individually or collectively:
determines whether there is another IoT device corresponding to the IoT device within a field of view of the camera; and
when determining that there is not the other IoT device, transmits the authentication request to the IoT device.

4. The electronic device of claim 3, wherein the at least one processor, when executing instructions stored in the memory, individually or collectively:
when determining that there is the other IoT device, identifies a second object corresponding to the other IoT device in the image;
determines whether the first object and the second object are identical to each other; and
when determining that the first object and the second object are not identical to each other, transmits the authentication request to the IoT device.

5. The electronic device of claim 4, wherein the at least one processor, when executing instructions stored in the memory, individually or collectively:
when determining that the first object and the second object are identical to each other, obtains depth information about the surrounding space through the camera;
identifies the IoT device based on the depth information; and
transmits the authentication request to the IoT device.

6. The electronic device of claim 1, wherein the at least one processor, when executing instructions stored in the memory, individually or collectively:
displays a user interface regarding the authentication;
receives the first user input through the user interface;
in response to determining that the directions of the IoT device and the electronic device match each other using the camera module and the second communication module, receives a second user input instructing to transmit the authentication request to the IoT device; and
in response to receiving the second user input, transmits the authentication request to the IoT device.

7. The electronic device of claim 2, wherein the at least one processor, in response to determining that the IoT device matches the electronic device, stores information about the IoT device received from the IoT device in the memory.

8. The electronic device of claim 2, wherein the at least one processor, when executing instructions stored in the memory, individually or collectively, in response to determining that the IoT device matches the electronic device, transmits information about the IoT device to an IoT server.

9. The electronic device of claim 1, wherein the authentication request includes identification information about the electronic device.

10. The electronic device of claim 1, wherein the at least one processor, when executing instructions stored in the memory, individually or collectively, in response to determining that the directions of the electronic device and the IoT device match each other, forms a second wireless communication link with the IoT device using the second communication module.

11. A method for operating an electronic device, the method comprising:
forming a first wireless communication link with an Internet-of-things (IoT) device using a Bluetooth technology;
receiving first authentication information from the IoT device;
identifying a first user input instructing to perform authentication of the IoT device;
determining whether directions of the IoT device and the electronic device match each other using a camera module and an ultra-wideband (UWB) communication technology;
when the directions of the IoT device and the electronic device match each other, transmitting an authentication request to the IoT device using the UWB communication technology;
receiving second authentication information about the IoT device using the UWB communication technology; and
when identifying that the second authentication information corresponds to the first authentication information, determining that the IoT device matches the electronic device.

12. The method of claim 11, further comprising:
obtaining an image of a surrounding space through the camera module;
identifying a location of a first object corresponding to the IoT device in the image;
identifying a location of the IoT device using the UWB communication technology; and
when identifying that the location of the first object corresponding to the IoT device in the image corresponds to the location of the IoT device obtained through the UWB communication technology, determining that the directions of the IoT device and the electronic device match each other.

13. The method of claim 12, further comprising:
determining whether there is another IoT device corresponding to the IoT device within a field of view of the camera module; and
when determining that there is not the other IoT device, transmitting the authentication request to the IoT device.

14. The method of claim 13, further comprising:
when determining that there is the other IoT device, identifying a second object corresponding to the other IoT device in the image;
determining whether the first object and the second object are identical to each other; and
when determining that the first object and the second object are not identical to each other, transmitting the authentication request to the IoT device.

15. The method of claim 14, further comprising:
when determining that the first object and the second object are identical to each other, obtaining depth information about the surrounding space through the camera;
identifying the IoT device based on the depth information; and
transmitting the authentication request to the IoT device.

16. The method of claim 11, further comprising:
displaying a user interface regarding the authentication;
receiving the first user input through the user interface;
in response to determining that the directions of the IoT device and the electronic device match each other using the camera module and the second communication module, receiving a second user input instructing to transmit the authentication request to the IoT device; and
in response to receiving the second user input, transmitting the authentication request to the IoT device.

17. The method of claim 12, further comprising:
in response to determining that the IoT device matches the electronic device, storing information about the IoT device received from the IoT device in memory of the electronic device.

18. The method of claim 12, further comprising:
in response to determining that the IoT device matches the electronic device, transmitting information about the IoT device to an IoT server.

19. The method of claim 11, further comprising:
in response to determining that the directions of the electronic device and the IoT device match each other, forming a second wireless communication link with the IoT device using the second communication module.

20. A computer program product comprising a storage medium storing instructions configured to be executed by at least one processor of an electronic device to perform a plurality of operations comprising:
forming a first wireless communication link with an Internet-of-things (IoT) device using a Bluetooth technology;
receiving first authentication information from the IoT device;
identifying a first user input instructing to perform authentication of the IoT device;
determining whether directions of the IoT device and the electronic device match each other using a camera module and an ultra-wideband (UWB) communication technology;
when the directions of the IoT device and the electronic device match each other, transmitting an authentication request to the IoT device using the UWB communication technology;
receiving second authentication information about the IoT device using the UWB communication technology; and
when identifying that the second authentication information corresponds to the first authentication information, determining that the IoT device matches the electronic device.
